(19) United States
(12) Patent Application Publication
(10) Pub. No.: US 2017/0046878 A1
(43) Pub. Date: Feb. 16, 2017

(54) AUGMENTED REALITY MOBILE APPLICATION

(71) Applicant: Revistor LLC, Raleigh, NC (US)

(72) Inventor: Robert Michael Dobslaw, Raleigh, NC (US)

(21) Appl. No.: 15/236,924

(22) Filed: Aug. 15, 2016

Related U.S. Application Data
(60) Provisional application No. 62/204,934, filed on Aug. 13, 2015.

(51) Int. Cl. G06T 19/00; G06K 9/32; G06T 7/00

(52) U.S. Cl. CPC G06T 19/006; G06T 7/0044; G06K 9/3208; G06T 2207/30244

(57) ABSTRACT

A mobile device computationally locates a three-dimensional virtual object model at a first virtual location corresponding to a first geographical location; computationally orients the three-dimensional virtual object model at a first virtual orientation; determines a real location and real orientation of the mobile device over time; captures real world image data over time; and displays over time an augmented reality view including the real world image data and the three-dimensional virtual object model in the first virtual location and first virtual orientation from a correct perspective of the mobile device based on the determined real location and real orientation of the mobile device. The correct perspective varies as the mobile device is relocated and reoriented over time by movement.

### CROSS-REFERENCE TO RELATED APPLICATION

This application claims the benefit of priority of U.S. provisional patent application No. 62/204,934, titled “AUGMENTED REALITY MOBILE APPLICATION,” filed on Aug. 13, 2015, which is incorporated herein in its entirety by this reference.

### TECHNICAL FIELD

The present invention relates to providing an immersive experience on a mobile device, and more specifically, to an augmented reality mobile application.

### BACKGROUND

Augmented reality applications present a live direct or indirect view of a physical, real-world environment whose elements are augmented (or supplemented) by computer-generated sensory input such as sound, video, graphics or GPS data. Thus, augmented reality builds upon the real, physical world around us by displaying information overlays and digital content tied to physical objects and locations. Augmented reality contrasts with virtual reality, which replaces a real world view with an entirely simulated one. Augmented reality views may be displayed using a variety of methods and displays, such as head mounted displays, projection systems, eyeglasses, and head-up displays.

Conventional augmented reality applications for mobile handheld devices, however, lack the ability to walk up to and around a virtual object within a real world space while maintaining proper perspective of the user. Instead, conventional augmented reality applications typically display a virtual object when a user walks up to a physical real world location and scans a QR code (e.g., on a plaque) or based on the user's GPS-determined location.

Additionally, conventional augmented reality applications do not allow for a time component such as displaying a virtual object differently depending on a particular time associated with the object (e.g., dates in past history) or displaying a sequence of the virtual object over time (e.g., a moving virtual object). Instead, virtual objects are typically either static or inter-actable in the present moment rather than in the past or historical context.

Accordingly, a need exists for a more flexible and immersive augmented reality application for mobile devices.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a computer-implemented method includes: computationally locating a three-dimensional virtual object model at a first virtual location corresponding to a first geographical location; computationally orienting the three-dimensional virtual object model at a first virtual orientation; determining a real location and real orientation of a mobile device over time; capturing real world image data by the mobile device over time; and displaying on the mobile device over time an augmented reality view including: the real world image data; and the three-dimensional virtual object model in the first virtual location and first virtual orientation from a correct perspective of the mobile device based on the determined real location and real orientation of the mobile device.

In at least one example, displaying on the mobile device over time an augmented reality view includes varying the correct perspective as the mobile device is relocated and reoriented over time by movement of the mobile device.

In at least one example, displaying on the mobile device over time an augmented reality view includes dynamically displaying to scale the three-dimensional virtual object model based at least in part on a distance between the first virtual location of the three-dimensional virtual object model and the determined real location of the mobile device.

In at least one example, the method further includes: computationally locating the three-dimensional virtual object model at a second virtual location corresponding to second geographical location; and computationally orienting the three-dimensional virtual object model at a second virtual orientation.

In at least one example, the method further includes: displaying on the mobile device over time an augmented reality view including: the real world image data; and the three-dimensional virtual object model in the second virtual location and second virtual orientation from a correct perspective of the mobile device based on the determined real location and real orientation of the mobile device.

In at least one example, the method further includes receiving user input indicating the first virtual location.

In at least one example, displaying on the mobile device over time an augmented reality view includes displaying a time sequence of views of the three-dimensional virtual object model, each of the views corresponding to a particular time prior to a current time.

In at least one embodiment, a mobile device includes: a display; and a processor. The processor is configured to: computationally locate a three-dimensional virtual object model at a first virtual location corresponding to a first geographical location; computationally orient the three-dimensional virtual object model at a first virtual orientation; determine a real location and real orientation of a mobile device over time; capture real world image data by the mobile device over time; and display on the display over time an augmented reality view including: the real world image data; and the three-dimensional virtual object model in the first virtual location and first virtual orientation from a correct perspective of the mobile device based on the determined real location and real orientation of the mobile device.

In at least one example, the processor is configured to display on the display over time an augmented reality view by varying the correct perspective as the mobile device is relocated and reoriented over time by movement of the mobile device.

In at least one example, the processor is configured to display on the mobile device over time an augmented reality view by dynamically displaying to scale the three-dimensional virtual object model based at least in part on a distance between the first virtual location of the three-dimensional virtual object model and the determined real location of the mobile device.

In at least one example, the processor is further configured to: computationally locate the three-dimensional virtual object model at a second virtual location corresponding to second geographical location; and computationally orient the three-dimensional virtual object model at a second virtual orientation.

In at least one example, the processor is further configured to: display on the mobile device over time an augmented reality view including: the real world image data; and the three-dimensional virtual object model in the second virtual location and second virtual orientation from a correct perspective of the mobile device based on the determined real location and real orientation of the mobile device.

In at least one example, the processor is further configured to receive user input indicating the first virtual location.

In at least one example, the processor is configured to display on the display over time an augmented reality view by displaying a time sequence of views of the three-dimensional virtual object model, each of the views corresponding to a particular time prior to a current time.

In at least one embodiment, a non-transitory computer-readable medium has recorded thereon computer-readable instructions that, when read by a computer processor of a mobile device, configure the computer processor to implement a method including: computationally locating a three-dimensional virtual object model at a first virtual location corresponding to a first geographical location; computationally orienting the three-dimensional virtual object model at a first virtual orientation; determining a real location and real orientation of a mobile device over time; capturing real world image data by the mobile device over time; and displaying on the mobile device over time an augmented reality view including: the real world image data; and the three-dimensional virtual object model in the first virtual location and first virtual orientation from a correct perspective of the mobile device based on the determined real location and real orientation of the mobile device.

In at least one example, displaying on the mobile device over time an augmented reality view includes varying the correct perspective as the mobile device is relocated and reoriented over time by movement of the mobile device.

In at least one example, displaying on the mobile device over time an augmented reality view includes dynamically displaying to scale the three-dimensional virtual object model based at least in part on a distance between the first virtual location of the three-dimensional virtual object model and the determined real location of the mobile device.

In at least one example, the method further includes: computationally locating the three-dimensional virtual object model at a second virtual location corresponding to second geographical location; and computationally orienting the three-dimensional virtual object model at a second virtual orientation.

In at least one example, the method further includes: displaying on the mobile device over time an augmented reality view including: the real world image data; and the three-dimensional virtual object model in the second virtual location and second virtual orientation from a correct perspective of the mobile device based on the determined real location and real orientation of the mobile device.

In at least one example, displaying on the mobile device over time an augmented reality view includes displaying a time sequence of views of the three-dimensional virtual object model, each of the views corresponding to a particular time prior to a current time.

According to one embodiment of the present invention, a method includes orienting a three-dimensional virtual object model (“virtual object”) in a real world space. The virtual object is associated with a geographic location in the real world space. A location, orientation, and elevation of a mobile device is determined over time. An augmented reality view of the virtual model and the real world space are display on the mobile device based on the location, orientation, and elevation of the virtual object and the mobile device.

A system includes a location module and a rendering engine. The location module is configured for determining a location, orientation, and elevation of a mobile device and a virtual object over time. The rendering engine for merging the data provided by the location module and displaying, on the mobile device, an augmented reality view of the virtual model and the real world space based on the location, orientation, and elevation of the virtual object and the mobile device.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1A is an augmented reality view, including real and virtual objects, taken from a first perspective for a mobile device display according to at least one embodiment.

FIG. 1B is an augmented reality view, including the real and virtual objects FIG. 1A, taken from a second perspective for a mobile device display according to at least one embodiment.

FIG. 2 is a flow chart showing method steps representing functional modules of an augmented reality application according to at least one embodiment of the subject matter described herein.

FIG. 3 is a map window for a mobile device display, according to at least one embodiment, by which a user can find real locations and search-available information and virtual objects.

FIG. 4 is an information and selection window for a mobile device display, according to at least one embodiment.

FIG. 5 is a map window for a mobile device display, according to at least one embodiment, by which a user can find real locations and search-available information and virtual objects.

FIG. 6 is an information and selection window for a mobile device display, according to at least one embodiment.

FIG. 7 is a window for a mobile device display, according to at least one embodiment, by which a user can select options for viewing and mapping.

FIG. 8 is a map window for a mobile device display, according to at least one embodiment, by which a user can access creation oriented functions.

FIG. 9 is a window for a mobile device display, according to at least one embodiment, for searching, editing, and orienting 3D objects in a real world space according to an embodiment of the subject matter described herein.

FIG. 10 is a window for a mobile device display, according to at least one embodiment, by which available models are searchable with free, purchase, and custom options.

FIG. 11 is a window for a mobile device display to a user, according to at least one embodiment, showing a user interface display of an individual virtual object placed within a real world space using a creation oriented function described herein.

FIG. 12 is a map window for a mobile device display, according to at least one embodiment, for a user to locate and/or place virtual objects on a real world map background. A user can click or hover to the corresponding virtual object.

FIG. 13 is a diagrammatic representation of a mobile device according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

The subject matter described herein includes an augmented reality mobile application. In contrast to conventional augmented reality applications, the present disclosure provides a more immersive experience where users can approach and traverse around and through generated 3D models. Accurate location and size depictions of historical troops, buildings, and famous persons are displayed on mobile devices such as smart phones using GPS and other user location and viewing perspective data. Superuser capabilities for history gurus are made available so as to facilitate their contributions of content. Additionally, the present disclosure allows users to choose a 3D model from catalogs (e.g., architecture, landscaping, historical, etc.) and place a selected model at a desired location to see how, for example, a new house might look on a vacant lot (e.g., view the Empire State building at a local park, place a spaceship in the sky above their house, visualize home remodels).

Functionalities described herein may be divided into separate or unified applications. For example, a visitor oriented application may provide content and usage scenarios focused on viewing recreated historical scenarios and buildings while a creation oriented application may provide a sandbox experience focused on home remodeling and landscaping. The visitor oriented and creation oriented functions may be parts of a single application as well having multiple functions available to different users for example or such multifunction available to users having authorized access to both visitor oriented and creation oriented functions.

For example, the visitor oriented application may preserve the legacy of historical sites by allowing guests to fully feel the experience. Enhanced guest experiences may include allowing users to travel through a generated 3D model while maintaining the proper 3D perspective of the model depending on the position of the user's viewpoint, utilizing accurate location and size depictions of historical troops, buildings, personalities (e.g., via GPS and other smart phone technology), to view the progression of a historical event. For example, a user may view virtual objects among real objects during the start, middle and end of a famous battle. History buffs can add and validate content.

The visitor oriented application may allow a user to place or visit a virtual object at a specific GPS location and see it in the real world with their mobile device. Users can walk towards the virtual object, away from the virtual object, and around the virtual object, while seeing the virtual object at the corresponding different angles and sizes as if the virtual object is actually present at that real world location.

The creation oriented application permits a user to preview a future project or have fun with family and friends locating and interacting with a host of 3D virtual objects. This may include allowing users to choose a 3D model from wide catalog (e.g., architecture, landscaping, historical, fantasy, etc.), to see how a future house will look on a vacant lot, to see how fully grown trees will look in a yard, to recreate a dinosaur battle in the neighborhood, or to place a sky scraper or pyramid at a local park.

Various aspects of the subject matter described herein include depictions of a 3D model without using a printed marker or using of image recognition capabilities of a mobile device to trigger the visualization of the virtual. Thus, even without the use of a location or boundary marker (e.g., QR code or geofence), in at least one embodiment, a 3D model is viewed in proper scale and location based on the user's approach and distance from the model, with the model viewed as placed at the proper elevation. Additionally, the subject matter described herein may include providing GPS accurate orientation of virtual models in a depiction of a real world space, and the ability for users to locate a 3D object at a location of their choosing in the real world, even without assistance of a marker, and the ability to scale the view of a 3D model upon a display appropriately based on a user's distance from it (life-size scaling based on distance), and the ability to display time-phased 3D renderings.

Example uses for the subject matter described herein include but are not limited to: Architecture—see how a design looks on existing lot or building prior to construction; Commercial and Residential Construction—see how a new building or renovation looks on existing lot prior to construction; Professional and Amateur Landscaping—see how new trees will look fully grown prior to planting; Recreation—entertain kids with skyscrapers and space ships in the yard or at local parks; House improvements—see how new furniture or upgrades will look in or around a house prior to purchase (pool, pool table, deck, shed); Tourism—enhance experiences at tourist sites with static or time phases visions of historical people and/or objects overlaid where they stood; Archival—via crowdsourcing, enlist teams to capture historical locations of people and objects for posterity (replace aging historical plaques, markers; Gaming—GPS-enabled territory expansion with different warring factions; Social—share spaceship formations, cities, armies, convoys created with other users.

In at least one embodiment, a sharing function permits virtual objects to be made available to multiple users. For example, a user may create virtual object or model scenes of any scale and their creation can be shared with one or more specified individual users or user groups, and can be shared publicly to any user if preferred by the creator. For example, a user permitted access may download a shared virtual object(s), model, or scene. The shared virtual object(s), model, or scene may be location specific, available for example only at the location specified by the creator, or may be available at any location selected by the user permitted sharing access. Virtual objects, models, and scenes may be made available for purchase in an online store or market place. User to user sharing may be conducted freely or for purchase.

As used herein, “orientation” refers to the determination of the relative physical direction or rotation of a virtual object about a fixed location in three dimensional space. Examples of orientation include upward, downward, forward, backward, pitch, yaw, angular position, attitude, etc. These may be translated into quantifiable values such as a number of degrees in the x, y, and z axes of a fixed three dimensional geometric space.

As used herein, “location” refers to the position of an object in two dimensional space. Examples of location include x,y geographical coordinates on the Earth's surface, whether expressed as GPS coordinates or otherwise. In its broadest interpretation, location may also include an elevation component describing the location of an object in the z or vertical direction.

As used herein, “elevation” refers to a height above a given level, such as sea level. Elevation may as be referred to as altitude. An angle of elevation may refer to the angle between a line drawn from an observer or instrument to an object above the observer or instrument and a horizontal line. For example, virtual objects may typically be placed such that the base of a virtual object is at the same elevation as the ground at a particular geographic location while the elevation of a mobile device near the same geographic location may be slightly higher. Thus, there will likely be a small angle of elevation where the mobile device and the virtual object are separated by a relatively large distance and a larger angle of elevation where the mobile device and the virtual object are separated by a relatively small distance.

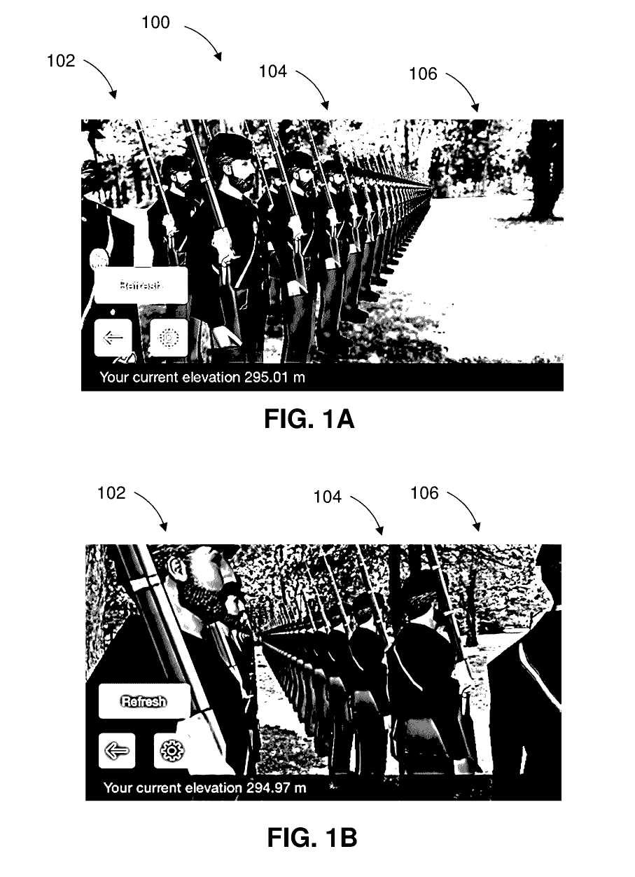

FIG. 1A is an augmented reality view 100, including real and virtual objects, taken from a first perspective for a mobile device display according to at least one embodiment. FIG. 1B is an augmented reality view, including the real and virtual objects FIG. 1A, taken from a second perspective for a mobile device display according to at least one embodiment. The virtual objects in the augmented reality view 100 include a first virtual object 102 shown as a first row of soldiers a second virtual object 104 shown as a second row of soldiers. The real objects in the augmented reality view 100 include a background 106 of trees, turf and other real world objects present at the location, time, and perspective of the mobile device upon which the augmented reality view 100 is displayed. Thus, due to a change of location and perspective between FIGS. 1A and 1B, the first virtual object 102, second virtual object 104, and background 106 are displayed differently accordingly.

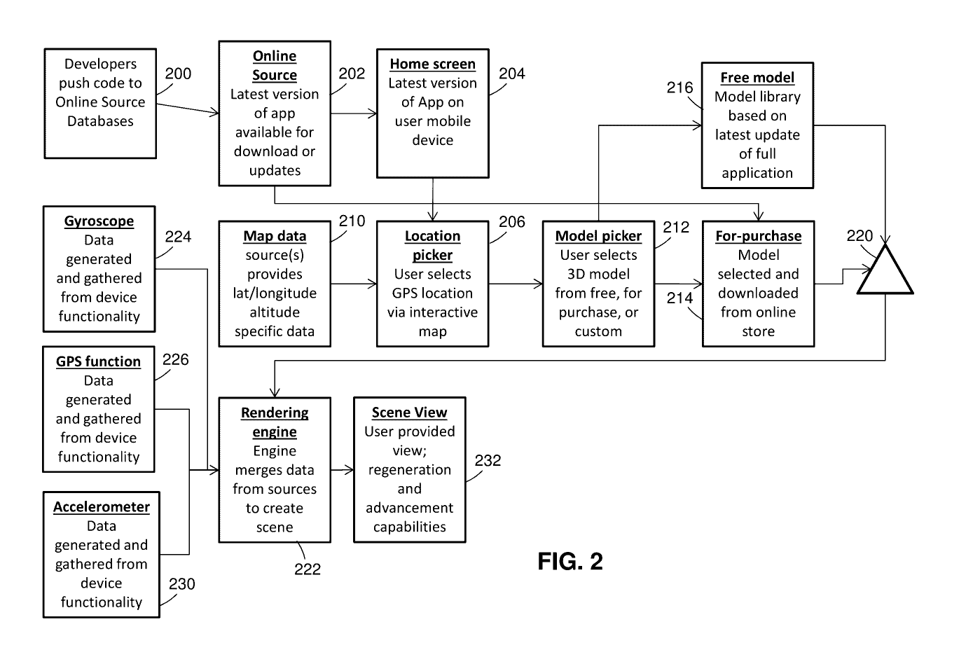

FIG. 2 is a flow chart showing method steps representing functional modules of an augmented reality application according to at least one embodiment of the subject matter described herein. In step 200, developers of software to be made available for download provide code to online sources. In step 202, users may download software for the mobile application described herein, or updates thereof, from an online source such as a digital content store. In step 204, the software downloaded is executed to install the application on a user mobile device.

Launching the application may present, in step 206, the user with a location picker that allows the user to select a GPS location using an interactive map (e.g., google maps). As represented by step 210, the interactive map may pull location information from one or more sources such as backend servers or locally cached data. For example, Google API may be a map data source.

In step 212, the user may then select a virtual model to place within a real world scene. Virtual models may be purchased in step 214 from an online software store and/or accessed in step 216 from those stored locally as part of the mobile application. In step 220, model attributes, whether purchased, locally stored, or created by the user using a virtual model creation and editing mode, are stored on the mobile device.

In step 222, the virtual model(s) are then fed into a rendering engine along with sensory-based location-determinative data from various other data sources. The rendering engine may acquire sensory-based location-determinative data from: an on-board gyroscope in step 224; on-board GPS in step 226; and an onboard accelerometer in step 230. The acquired sensory-based location-determinative data is used to determine location, orientation, elevation, acceleration, and camera view of the mobile device.

In step 222, the rendering engine merges these data to generate and display, in step 232, an augmented view of the scene that includes both real objects in real world perspective overlaid with the virtual object(s). This augmented view may be dynamically/live updated as the user moves relative to the virtual object(s) in order to properly display the scene. Dynamically updating the scene may include changing the size or orientation of the virtual object(s) in the scene such that it remains consistent to the changing perspective of the user as determined by the mobile device. Alternatively, or additionally, dynamically updating the scene may include changing the appearance, location, or orientation of the virtual object based on a transition of time even if the location of the user does not change. For example, the user may be stationary and view troops marching to battle during a recreation of an historical event. As such, the location, appearance, etc. of the virtual troops may change from the beginning of a battle until the end regardless of whether the user moves.

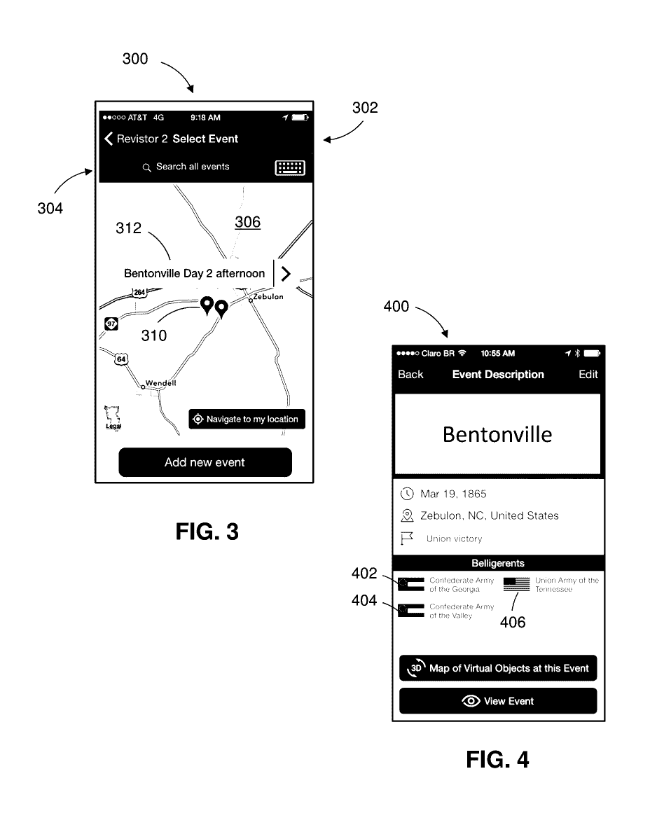

FIG. 3 is a map window 300 for a mobile device display, according to at least one embodiment, by which a user can find real locations and search-available information and virtual objects, for example those representing historical events. A map header 302 includes an operable search bar 304 by which search queries for virtual objects and real world locations can entered. In response, map information including roadways, municipalities and other sovereignties, and real points of information are displayed upon a map 306. The map 306 also includes selectable markers indicating virtual objects relevant to entered search terms or the area displayed. The user can click on a selectable marker to access detailed information relevant to the subject matter of the marker. A selectable marker can be clicked to cause a next-level information and selection box to appear on the map 306 or header 302, the box including textual information about a historical event, optionally for which one or more virtual objects are available in the vicinity of the marker. Further clicking or selection of an item in a box or menu that appears allows users to access even further information or selections for increasingly detailed descriptions of items clicked or selected.

In the example of FIG. 3, a first selectable marker 310 representing a historical event is shown on the map 306. The first selectable marker 310 has been selected by clicking or hovering nearby to cause the information and selection box 312 to appear, referencing the first selectable marker 310 by proximity or pointer as shown. The information and selection box 312 in the illustrated example permits the user to select among a progression of time selections, for example the afternoon of the second day of the Bentonville battle is shown as an available time selection. Other time selections may be available by further clicking or scrolling.

Selecting an available event or time selection causes next-level information to be displayed. FIG. 4 is an information and selection window 400 for a mobile device display, according to at least one embodiment. By selection of an item corresponding to the afternoon of the second day of the Bentonville battle in the information and selection box 312 of FIG. 3, the information window 400 of FIG. 4 is displayed in the illustrated example. Even further detailed information may be accessed through the information and selection window 400 of FIG. 4. For example, the belligerents listed as participating in the events of the time selection for which the next-level information is displayed in FIG. 4 can be further selected to access even further information and selections regarding, in the illustrated example, the Confederate Army of Georgia at information and selection box or item 402, the Confederate Army of the Valley at information and selection box or item 404, and the Union Army of Tennessee at information and selection box or item 406. Thus, FIGS. 3 and 4 represent that information, selections, and cross-referencing thereof are available by navigation among the windows of the mobile application(s) described herein.

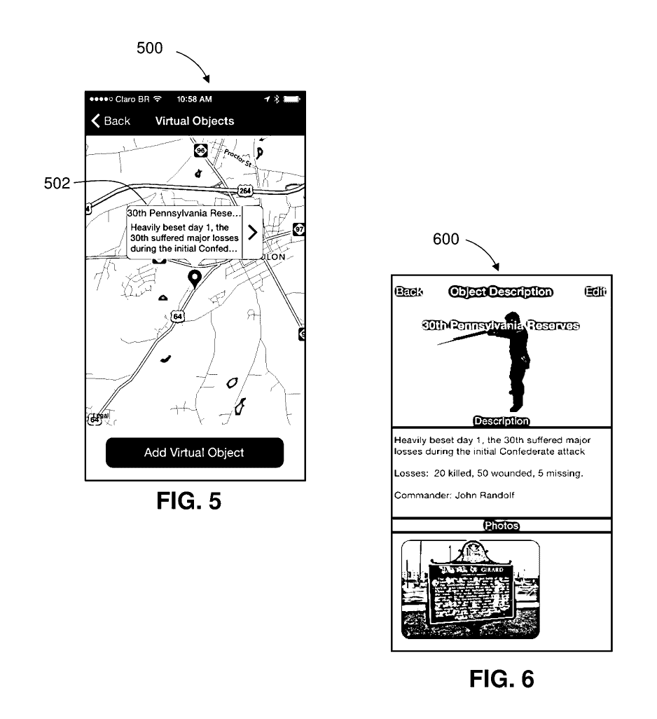

FIG. 5 is a map window 500 for a mobile device display, according to at least one embodiment, by which a user can find real locations and search-available information and virtual objects, for example those representing historical events. An information and selection box 502 is shown with textual information regarding a particular combatant in the Bentonville battle. FIG. 6 is an information and selection window 600 for a mobile device display, according to at least one embodiment. By selection of an item corresponding to the 30^{th} Pennsylvania Reserves in the information and selection box 502 of FIG. 5, the information window 600 of FIG. 6 is displayed in the illustrated example. Thus, FIGS. 5 and 6 represent that information, selections, and cross-referencing thereof are available by navigation among the windows of the mobile application(s) described herein.

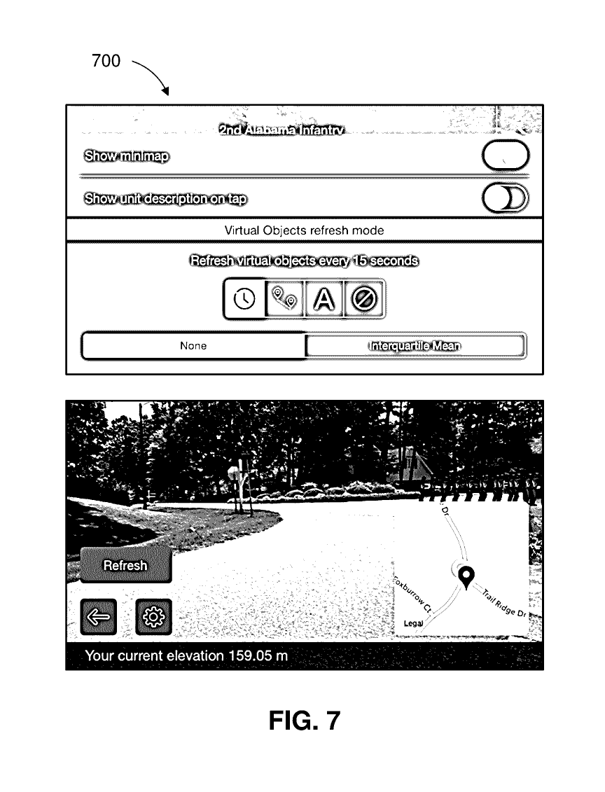

FIG. 7 is a window 700 for a mobile device display, according to at least one embodiment, by which a user can select options for viewing and mapping. In FIG. 7, additional details are overlaid on a perspective view according to an embodiment of the subject matter described herein.

According to the above described examples relating to, user can access a searchable map to see available historical events, and the progression of history can be relived via different events (FIG. 3). Clicking on an available event for example prompts the display of more detailed information (FIG. 4). At each event, for further example, the user can view a map of available virtual objects, and users can click on each virtual object for a short description (FIG. 5). Users can dig deeper and learn more about the virtual object (FIG. 6). Users can view an event and see available virtual objects on their screen, and users can walk amidst the virtual objects as their view refreshes to display virtual objects from the changing perspective of their mobile device (FIGS. 1A-1B).

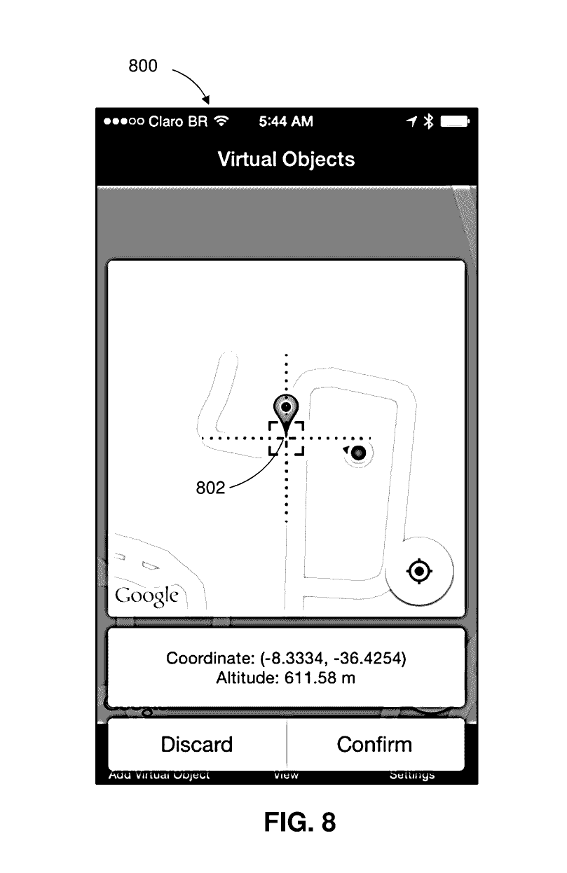

FIG. 8 is a map window 800 for a mobile device display, according to at least one embodiment, by which a user can access creation oriented functions. A user can view a map of virtual objects they have placed. The user can add virtual objects, for example by clicking on a map location 802 in FIG. 8, the user selects a location for a new virtual object, and can confirm or discard its creation.

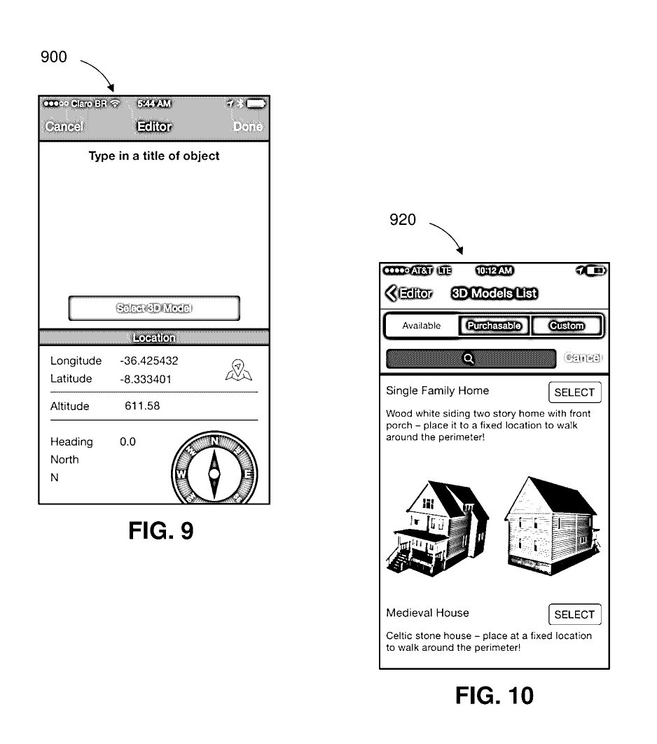

FIG. 9 is a window 900 for a mobile device display to a user, according to at least one embodiment, for searching, editing, and orienting 3D objects in a real world space according to an embodiment of the subject matter described herein. The user is provided an editor to choose a title, a 3D model, orientation and other options.

FIG. 10 is a window 920 for a mobile device display to a user, according to at least one embodiment, by which available models are searchable with free, purchase, and custom options.

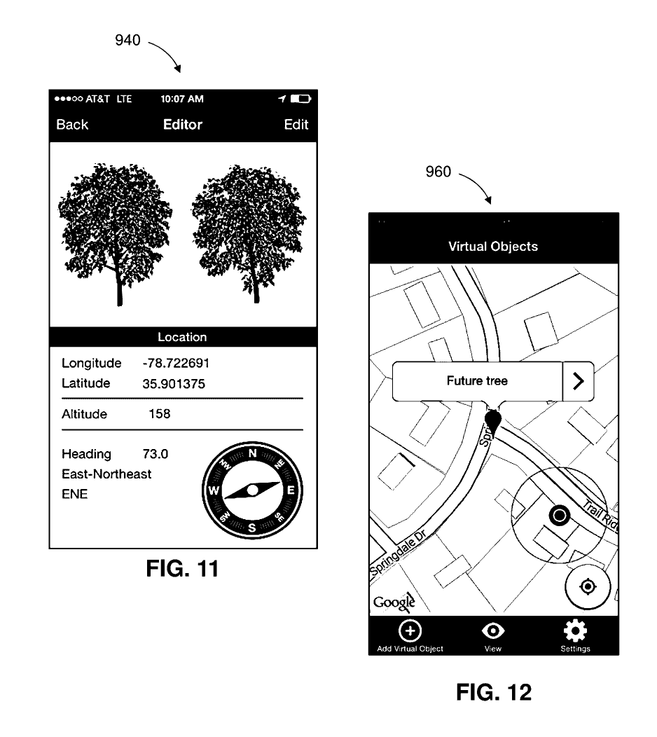

FIG. 11 is a window 940 for a mobile device display to a user, according to at least one embodiment, showing a user interface display of an individual virtual object placed within a real world space using the creation oriented function described herein. After model selection, a user can review 3D object settings. For example, elevation and orientation can be updated if desired.

FIG. 12 is a map window 960 for a mobile device display, according to at least one embodiment, for a user to locate and/or place virtual objects on a real world map background. A user can click or hover at the corresponding virtual object. The example of FIG. 12 corresponds to the placement of a virtual tree. Further viewing by clicking or hovering can prompt a view via the display of the mobile device of an augmented reality view, including real and virtual objects, taken from the perspective for the mobile, for example as shown in FIGS. 1A and 1B. The example of FIG. 12 corresponds to the placement of a virtual tree, whereas FIGS. 1A and 1B relate to the Bentonville battle. The subject matter of virtual objects for creation is not limited by these subject matter examples.

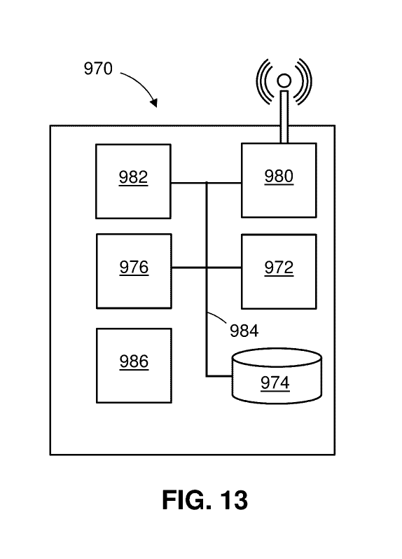

FIG. 13 is a diagrammatic representation of a computing device 970 of which the above described mobile device may be an example. The computing device 970 includes components such as a processor 972, and a storage device or memory 974. A communications controller 976 facilitates data input and output to a radio 980. Input and output devices 982 such as a screen and keyboard or other buttons facilitate interface with a user. Examples of input and output devices 982 include, but are not limited to, alphanumeric input devices, mice, electronic styluses, display units, touch screens, signal generation devices (e.g., speakers) or printers, and microphones. A system bus 984 or other link interconnects the components of the computing device 970. A power supply 986, which may be a battery or voltage device plugged into a wall or other outlet, powers the computing device 970 and its onboard components.

By way of example, and not limitation, the processor 972 may be a general-purpose microprocessor such as a central processing unit (CPU), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and other manipulations of information.

The storage device or memory 974 may include, but is not limited to: volatile and non-volatile media such as cache, RAM, ROM, EPROM, EEPROM, FLASH memory or other solid state memory technology, disks or discs or other optical or magnetic storage devices, or any other medium that can be used to store computer readable instructions and which can be accessed by the processor 972. In at least one example, the storage device or memory 974 represents a non-transitory medium upon which computer readable instructions are stored. For example, a user downloads and runs software for the mobile application described herein, or updates thereof, from an online source such as a digital content store as described in the preceding with reference to FIG. 2.

Above examples relate expressly to virtual objects based on historical events, and the progression of historical events as viewed by the activities of such virtual objects. These descriptions nonetheless relate as well other historical events, for example the Battle of Gettysburg, and non-historical or fictional events as well. Subject matters for virtual objects and their progressions can vary according to the content creators wish to provide for viewing. Other subject matters include, but are not limited to: futuristic themes based on forecasting or imagination; fantasy themes based on children's books or movies; subject matters based on media characters or other media content; holiday based themes; and more.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
computationally locating a three-dimensional virtual object model at a first virtual location corresponding to a first geographical location;
computationally orienting the three-dimensional virtual object model at a first virtual orientation;
determining a real location and real orientation of a mobile device over time;
capturing real world image data by the mobile device over time; and
displaying on the mobile device over time an augmented reality view including:
the real world image data; and
the three-dimensional virtual object model in the first virtual location and first virtual orientation from a correct perspective of the mobile device based on the determined real location and real orientation of the mobile device.

2. The computer-implemented method of claim 1, wherein displaying on the mobile device over time an augmented reality view comprises varying the correct perspective as the mobile device is relocated and reoriented over time by movement of the mobile device.

3. The computer-implemented method of claim 1, wherein displaying on the mobile device over time an augmented reality view comprises dynamically displaying to scale the three-dimensional virtual object model based at least in part on a distance between the first virtual location of the three-dimensional virtual object model and the determined real location of the mobile device.

4. The computer-implemented method of claim 1, further comprising:
computationally locating the three-dimensional virtual object model at a second virtual location corresponding to second geographical location; and
computationally orienting the three-dimensional virtual object model at a second virtual orientation.

5. The computer-implemented method of claim 4, further comprising:
displaying on the mobile device over time an augmented reality view including:
the real world image data; and
the three-dimensional virtual object model in the second virtual location and second virtual orientation from a correct perspective of the mobile device based on the determined real location and real orientation of the mobile device.

6. The computer-implemented method of claim 1, further comprising receiving user input indicating the first virtual location.

7. The computer-implemented method of claim 1, wherein displaying on the mobile device over time an augmented reality view comprises displaying a time sequence of views of the three-dimensional virtual object model, each of the views corresponding to a particular time prior to a current time.

8. A mobile device comprising:
a display; and
a processor configured to:
computationally locate a three-dimensional virtual object model at a first virtual location corresponding to a first geographical location;
computationally orient the three-dimensional virtual object model at a first virtual orientation;
determine a real location and real orientation of a mobile device over time;
capture real world image data by the mobile device over time; and
display on the display over time an augmented reality view including:
the real world image data; and
the three-dimensional virtual object model in the first virtual location and first virtual orientation from a correct perspective of the mobile device based on the determined real location and real orientation of the mobile device.

9. The mobile device of claim 8, wherein the processor is configured to display on the display over time an augmented reality view by varying the correct perspective as the mobile device is relocated and reoriented over time by movement of the mobile device.

10. The mobile device of claim 8, wherein the processor is configured to display on the mobile device over time an augmented reality view by dynamically displaying to scale the three-dimensional virtual object model based at least in part on a distance between the first virtual location of the three-dimensional virtual object model and the determined real location of the mobile device.

11. The mobile device of claim 8, wherein the processor is further configured to:
computationally locate the three-dimensional virtual object model at a second virtual location corresponding to second geographical location; and
computationally orient the three-dimensional virtual object model at a second virtual orientation.

12. The mobile device of claim 11, wherein the processor is further configured to:
display on the mobile device over time an augmented reality view including:
the real world image data; and
the three-dimensional virtual object model in the second virtual location and second virtual orientation from a correct perspective of the mobile device based on the determined real location and real orientation of the mobile device.

13. The mobile device of claim 8, wherein the processor is further configured to receive user input indicating the first virtual location.

14. The mobile device of claim 8, wherein the processor is configured to display on the display over time an augmented reality view by displaying a time sequence of views of the three-dimensional virtual object model, each of the views corresponding to a particular time prior to a current time.

15. A non-transitory computer-readable medium having recorded thereon computer-readable instructions that, when read by a computer processor of a mobile device, configure the computer processor to implement a method comprising:
computationally locating a three-dimensional virtual object model at a first virtual location corresponding to a first geographical location;
computationally orienting the three-dimensional virtual object model at a first virtual orientation;
determining a real location and real orientation of a mobile device over time;
capturing real world image data by the mobile device over time; and
displaying on the mobile device over time an augmented reality view including:
the real world image data; and
the three-dimensional virtual object model in the first virtual location and first virtual orientation from a correct perspective of the mobile device based on the determined real location and real orientation of the mobile device.

16. The non-transitory computer-readable medium of claim 15, wherein displaying on the mobile device over time an augmented reality view comprises varying the correct perspective as the mobile device is relocated and reoriented over time by movement of the mobile device.

17. The non-transitory computer-readable medium of claim 15, wherein displaying on the mobile device over time an augmented reality view comprises dynamically displaying to scale the three-dimensional virtual object model based at least in part on a distance between the first virtual location of the three-dimensional virtual object model and the determined real location of the mobile device.

18. The non-transitory computer-readable medium of claim 15, wherein the method further comprises:
computationally locating the three-dimensional virtual object model at a second virtual location corresponding to second geographical location; and
computationally orienting the three-dimensional virtual object model at a second virtual orientation.

19. The non-transitory computer-readable medium of claim 18, wherein the method further comprises:
displaying on the mobile device over time an augmented reality view including:
the real world image data; and
the three-dimensional virtual object model in the second virtual location and second virtual orientation from a correct perspective of the mobile device based on the determined real location and real orientation of the mobile device.

20. The non-transitory computer-readable medium of claim 15, wherein displaying on the mobile device over time an augmented reality view includes displaying a time sequence of views of the three-dimensional virtual object model, each of the views corresponding to a particular time prior to a current time.
